(19) United States
(12) Patent Application Publication
(10) Pub. No.: US 2007/0019980 A1
(43) Pub. Date: Jan. 25, 2007

(54) Developing apparatus and method for supplying voltage to a developing apparatus

(75) Inventors: Min-seon Kim, Suwon-si (KR); Seung-deog An, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co. Ltd.

(21) Appl. No.: 11/488,755

(22) Filed: Jul. 19, 2006

(30) Foreign Application Priority Data
Jul. 19, 2005 (KR) 2005-0065422

(51) Int. Cl. G03G 15/00; G03G 15/01

(52) U.S. Cl. 399/90; 399/228; 399/223

(57) ABSTRACT

A developing apparatus and method are provided. In one exemplary embodiment the apparatus includes a voltage supply portion, a voltage switching portion and a central processing portion for controlling the switching. The voltage supply portion supplies a voltage to a plurality of developers. The voltage switching portion provides a voltage supplied by the voltage supply portion to one of the developers through switching operation and grounds the developers other than the developer to which the voltage is supplied. The central processing portion controls the switching operation of the voltage switching portion. Also provided is a method of supplying voltage to a developer apparatus.

### CROSS-REFERENCE TO RELATED PATENT APPLICATIONS

This application claims the benefit under 35 U.S.C. §119(a) of Korean Patent Application No. 2005-0065422, filed on Jul. 19, 2005, in the Korean Intellectual Property Office, the entire disclosure of which is hereby incorporated by reference.

### BACKGROUND OF THE INVENTION

1. Field of the Invention

The present invention relates to an image forming apparatus and method. More particularly, the present invention relates to a method and apparatus for switching the supply of a high voltage to a developer of an image forming apparatus to prevent contamination of the developer.

2. Description of the Related Art

In general, an image forming apparatus, such as a color printer or a multifunctional printer, includes as major constituent elements a solenoid operated by a signal for switching a high voltage, a metal plate operated as a contact point of a high voltage, a push lever switching a force of the solenoid in the horizontal direction to the vertical direction, and resistors for high voltages to prevent contamination of a developer. A printed circuit board or a bracket is used to fix the above elements.

When a high voltage from a supply source is supplied to a high voltage switching apparatus, the solenoid distributes the high voltage to each of the developers.

FIG. 1 shows a conventional voltage switching apparatus. Referring to FIG. 1, for example, when only a yellow solenoid 10 is on and the other solenoids 20, 30, and 40 are off, a high voltage IN1 is supplied to only a yellow developer Y. The other developers, that is, a magenta developer M, a cyan developer C, and a black developer K, receive the high voltage that is supplied to the yellow developer via high voltage resistors R1, R2, R3, and R4. Thus, the contamination of the developers due to the attachment of toner can be prevented. That is, the contamination of the magenta developer M can be prevented as the magenta developer receives a high voltage through the high voltage resistors RI and R2 that are connected in series, the contamination of the cyan developer can be prevented as the cyan developer C receives a high voltage through the high voltage resistors RI and R3 that are connected in series, and the contamination of the black developer K can be prevented as the black developer receives a high voltage through the high voltage resistors RI and R4 that are connected in series. The supply of a predetermined voltage to the other developers while a normal high voltage is supplied to one developer is to prevent the developer from being contaminated by toner.

As described above, according to the conventional technology, a voltage at a level that does not generate contamination is supplied to the remaining developers using the additional high voltage resistors after the switching of a high voltage is performed to prevent the contamination of the developers. However, it is disadvantageous that additional high voltage resistors are needed to prevent the contamination. That is, providing the high voltage resistors increases space for circuit configuration and also increases costs. Furthermore, when the toner or developing conditions are changed, since the high voltage resistors are fixed, the voltage needs to be readjusted.

Accordingly, there is a need for an improved apparatus and method for switching the power supply to a developer to prevent contamination of the developer.

### SUMMARY OF THE INVENTION

To solve the above and/or other problems, the exemplary aspects of the present invention provide a developing apparatus and method of use which does not need an additional high voltage resistor for preventing the contamination of developers.

According to an exemplary aspect of the present invention, there is provided an apparatus and method for preventing contamination of a developer wherein a voltage is supplied to a plurality of developers by a voltage supply portion, a voltage is supplied by the voltage supply portion to one of the developers through switching operation of a voltage switching portion and the developers other than the developer to which the voltage is supplied are grounded and the switching operation of the voltage switching portion is controlled by a central processing portion.

According to another exemplary aspect of the present invention, there is provided an apparatus and method for preventing developer contamination wherein a voltage is supplied to a plurality of developers by a voltage supply portion, a voltage is supplied by the voltage supply portion to one of the developers through switching operation of a voltage switching portion and a contamination prevention voltage is supplied to the developers other than the developer to which the voltage of the voltage supply portion is supplied and the switching operation of the voltage switching portion is controlled by a central processing portion controlling.

### BRIEF DESCRIPTION OF THE DRAWINGS

The above and other features and advantages of the present invention will become more apparent by describing in detail exemplary embodiments thereof with reference to the attached drawings in which:

FIG. 1 is a circuit diagram of a conventional voltage switching apparatus;

FIG. 2 is a block diagram of a developing apparatus according to an exemplary embodiment of the present invention;

FIG. 3 is a circuit diagram of a voltage switching portion in the developer contamination prevention apparatus of FIG. 2; and

FIG. 4 is a circuit diagram of a voltage switching portion in a developing apparatus according to another exemplary embodiment of the present invention.

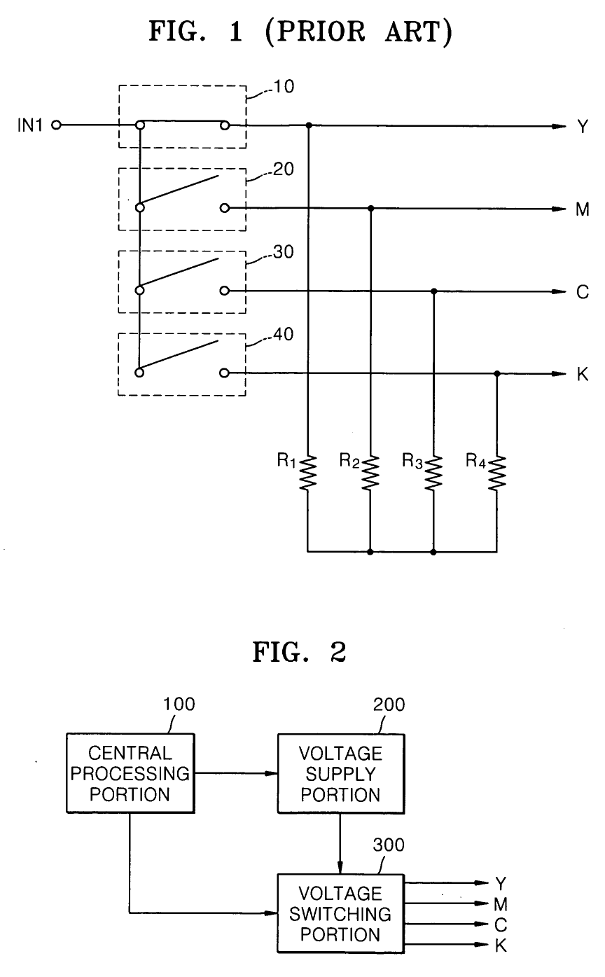

Throughout the drawings, the same drawing reference numerals will be understood to refer to the same elements, features, and structures.

### DETAILED DESCRIPTION OF EXEMPLARY EMBODIMENTS

Referring to FIG. 2, a developing apparatus according to an exemplary embodiment of the present invention includes a central processing portion 100, a voltage supply portion 200, and a voltage switching portion 300. The central processing portion 100 controls the switching operation of the voltage switching portion 300. The central processing portion 100 controls the switching operation of the voltage switching portion 300 so that a voltage supplied by the voltage supply portion 200 is supplied to any one of the developers. The central processing portion 100 controls the switching operation of the voltage switching portion 300 so that the voltage supplied by the voltage supply portion 200 is not supplied to the developers other than the developer to which the voltage is desired to be supplied.

The voltage supply portion 200 supplies a voltage to a plurality of developers. As the voltage supply portion 200 supplies a high voltage to the voltage switching portion 300, the voltage is supplied to the developers through the switching operation of the voltage switching portion 300.

The voltage switching portion 300 provides the voltage supplied by the voltage supply portion 200 to any one of the developers, that is, yellow Y, magenta M, cyan C, and black K through the switching operation. The voltage switching portion 300 grounds the developers other than the developer to which the voltage is supplied.

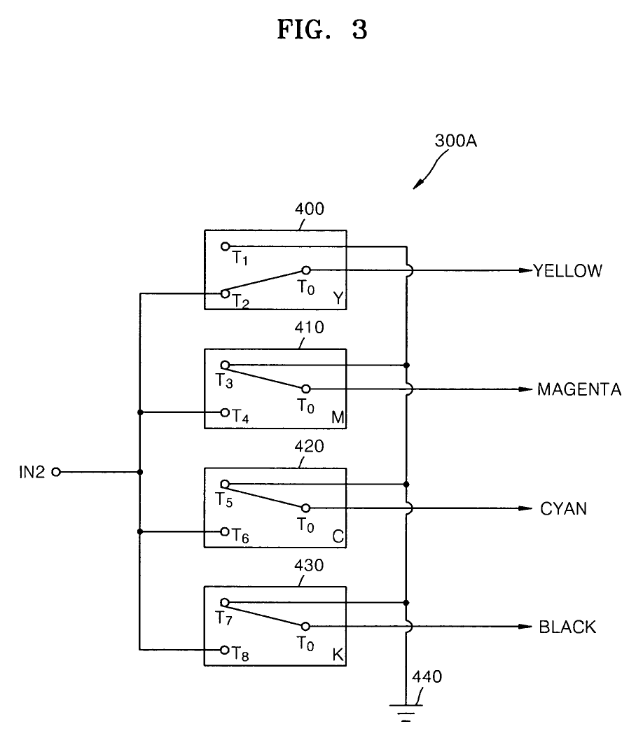

FIG. 3 shows a voltage switching portion 300A according to an exemplary embodiment of the present invention. Referring to FIG. 3, the voltage switching portion 300A includes first through fourth switches 400, 410, 420, and 430 and a ground portion 440. The first through fourth switches 400, 410, 420, and 430 perform switching operations to provide the voltage supplied by the voltage supply portion 200 to any one of the developers. For example, assuming that a voltage supplied by the voltage supply portion 200 through an input port IN2 is supplied to the yellow developer, the first switch 400 performs a switching operation to connect a terminal T0_{Y} and a terminal T2. As the terminal T0_{Y} and the terminal T2 are connected, the voltage of the voltage supply portion 200 is supplied to the yellow developer. The second switch 410 performs switching operation to connect the terminal T0_{M} and a terminal T3 so that the voltage of the voltage supply portion 200 is prevented from being supplied to the magenta developer. The third switch 420 performs switching operation to connect the terminal T0_{C} and a terminal T5 so that the voltage of the voltage supply portion 200 is prevented from being supplied to the cyan developer. The fourth switch 430 performs switching operation to connect the terminal T0_{K} and a terminal T7 so that the voltage of the voltage supply portion 200 is prevented from being supplied to the black developer.

In an exemplary embodiment, the first through fourth switches 400, 410, 420, and 430 may be relays. By opening and closing electric contact points, the relays perform the switching operation to supply the voltage to the developers. The ground portion 440 is connected to the first through fourth switches 400, 410, 420, and 430 to ground the developers other than the developer to which the voltage is supplied. For example, assuming that the voltage of the voltage supply portion 200 is supplied to the yellow developer, the first switch 400 performs switching operation to connect the terminal T0_{Y} and the terminal T2. At this time, as the second switch 410 performs switching operation to connect the terminal T0_{M} and the terminal T3, the magenta developer is grounded by the ground portion 440. Also, as the third switch 420 performs switching operation to connect the terminal T0_{C} and the terminal T5, the cyan developer is grounded by the ground portion 440. As the fourth switch 430 performs switching operation to connect the terminal T0_{K} and the terminal T7, the black developer is grounded by the ground portion 440.

As described above, as the magenta, cyan, and black developers are grounded by the switching operations of the second switch 410, the third switch 420, and the fourth switch 430, contaminants such as toner are prevented from adhering to the magenta, cyan, and black developers due to the voltage supplied by the voltage supply portion 200.

In an exemplary embodiment, the voltage supply portion 200 and the voltage switching portion 300 are integrally formed into a single board. As the voltage supply portion 200 and the voltage switching portion 300 are integrally formed into a single board, an additional high voltage switching harness and plate are not needed which facilitates simplification of the circuit configuration.

A developing apparatus according to another exemplary embodiment of the present invention will be described below with reference to the accompanying drawings. Since the central processing portion 100 and the voltage supply portion 200 are the same as those described with reference to FIG. 2, detailed descriptions thereof will be omitted herein.

The voltage switching portion 300 provides the voltage supplied by the voltage supply portion 200 to any one of the developers through the switching operation and provides a voltage to prevent contamination to the developers other than the developer to which the voltage is supplied. In the present exemplary embodiment, the voltage supply portion 200 and the voltage switching portion 300 are integrally formed into a single board.

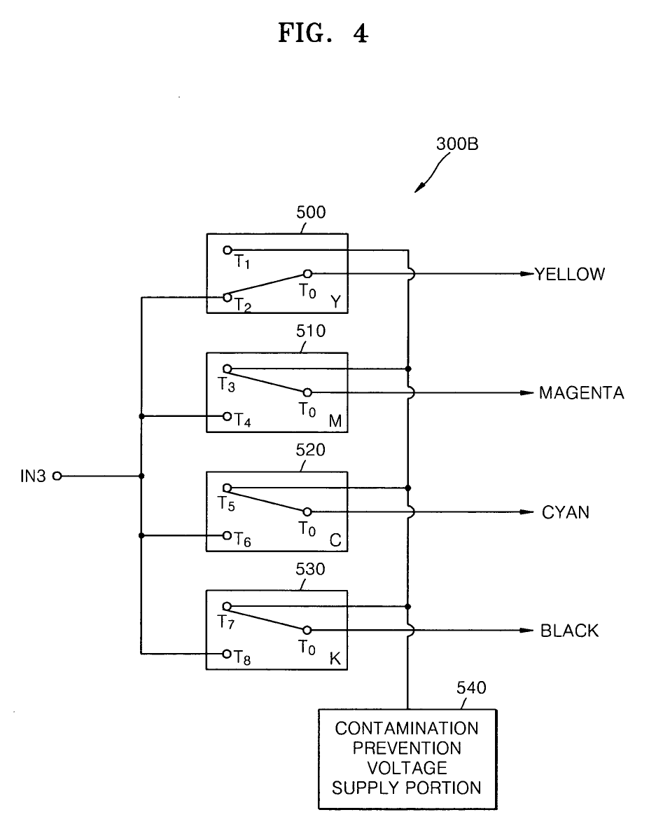

FIG. 4 shows a voltage switching portion 300B according to another embodiment of the present invention. The voltage switching portion 300B includes first through fourth switches 500, 510, 520, and 530 and a contamination prevention voltage supply portion 540.

The first through fourth switches 500, 510, 520, and 530 perform switching operation to provide the voltage supplied by the voltage supply portion 200 to anyone of the developers. For example, assuming that the voltage supplied by the voltage supply portion 200 through an input port IN3 is supplied to the yellow developer, the first switch 500 performs switching operation to connect a terminal T0_{Y} and a terminal T2. As the terminal T0_{Y} and the terminal T2 are connected, the voltage of the voltage supply portion 200 is supplied to the yellow developer. The second switch 510 performs switching operation to connect the terminal T0_{M} and a terminal T3 so that the voltage of the voltage supply portion 200 is prevented from being supplied to the magenta developer. The third switch 520 performs switching operation to connect the terminal T0_{C} and a terminal T5 so that the voltage of the voltage supply portion 200 is prevented from being supplied to the cyan developer. The fourth switch 530 performs switching operation to connect the terminal T0_{K} and a terminal T7 so that the voltage of the voltage supply portion 200 is prevented from being supplied to the black developer.

In an exemplary embodiment, the first through fourth switches 500, 510, 520, and 530 supply a contamination prevention voltage to the developers other than the developer to which the voltage is supplied. For example, assuming that the voltage of the voltage supply portion 200 is supplied to the yellow developer, the first switch 500 performs switching operation to connect the terminal T0_{Y} and the terminal T2. At this time, as the second switch 510 performs switching operation to connect the terminal T0_{M} and the terminal T3, the magenta developer is connected to the contamination prevention voltage supply portion 540. The contamination prevention voltage supply portion 540 supplies an additional voltage for preventing contamination to the magenta developer. Thus, the magenta developer can prevent adhering of contaminants by means of the voltage supplied by the contamination prevention voltage supply portion 540. Also, as the third switch 520 performs switching operation to connect the terminal T0_{C} and the terminal T5, the cyan developer is connected to the contamination prevention voltage supply portion 540. The contamination prevention voltage supply portion 540 supplies an additional voltage for preventing contamination to the cyan developer. Thus, the cyan developer can prevent adhering of contaminants by means of the voltage supplied by the contamination prevention voltage supply portion 540. As the fourth switch 530 performs switching operation to connect the terminal T0_{K} and the terminal T7, the black developer is connected to the contamination prevention voltage supply portion 540. The contamination prevention voltage supply portion 540 supplies an additional voltage for preventing contamination to the black developer. Thus, the black developer can prevent adhering of contaminants by means of the voltage supplied by the contamination prevention voltage supply portion 540. The voltage supplied by the contamination prevention voltage supply portion 540 may be lower than that supplied by the voltage supply portion 200 and may also be variable based on the development conditions.

As described above, according to an exemplary developing apparatus, when a high voltage is supplied to a developer, since an additional high voltage resistor to prevent contamination of the other developer is not needed, there is no need to adjust a voltage according to the installed resistor even when the condition of development is changed. Also, since the voltage supply portion and the voltage switching portion may be integrally formed into a single board, additional high voltage switching harness and plate are not needed so that the configuration of a circuit can be simplified. Furthermore, since the solenoid that is conventionally used to switch a high voltage may be replaced by a relay, the manufacturing cost and the volume of a high voltage switching circuit can be reduced.

While the invention has been shown and described with reference to certain embodiments thereof, it will be understood by those skilled in the art that various changes in form and details may be made therein without departing from the spirit and scope of the invention as defined by the appended claims.

What is claimed is:

1. A developing apparatus comprising:
a voltage supply portion to supply voltage to a plurality of developers;
a voltage switching portion providing a voltage supplied by the voltage supply portion to one of the developers through switching operation and grounding the developers other than the developer to which the voltage is supplied; and
a processing portion controlling the switching operation of the voltage switching portion.

2. The developing apparatus as claimed in claim 1, wherein the voltage switching portion comprises:
a plurality of switches performing the switching operation to provide the voltage supplied by the voltage supply portion to one of the developers; and
a ground portion connected to the switches to ground the developers other than the developer to which the voltage is supplied.

3. The developing apparatus as claimed in claim 2, wherein the switches are relays.

4. The developing apparatus as claimed in claim 1, wherein the voltage supply portion and the voltage switching portion are integrally formed.

5. A developing apparatus comprising:
a voltage supply portion to supply voltage to a plurality of developers;
a voltage switching portion providing a voltage supplied by the voltage supply portion to one of the developers through switching operation and a contamination prevention voltage to the developers other than the developer to which the voltage of the voltage supply portion is supplied; and
a processing portion controlling the switching operation of the voltage switching portion.

6. The developing apparatus as claimed in claim 5, wherein the voltage switching portion comprises:
a plurality of switches performing the switching operation to provide the voltage supplied by the voltage supply portion to one of the developers; and
a contamination prevention voltage supply portion connected to the switches to supply a contamination prevention voltage to the developers other than the developer to which the voltage of the voltage supply portion is supplied.

7. The developing apparatus as claimed in claim 6, wherein the switches are relays.

8. The developing apparatus as claimed in claim 5, wherein the voltage supply portion and the voltage switching portion are integrally formed.

9. The developing apparatus as claimed in claim 4, wherein the voltage supply portion and the voltage switching portion are integrally formed on a single board.

10. The developing apparatus as claimed in claim 8, wherein the voltage supply portion and the voltage switching portion are integrally formed on a single board.

11. A method of supplying voltage to a developing apparatus, comprising:
selecting a developer from among a plurality of developers;
providing a voltage to the selected developer; and
providing a ground potential to the developers other than the selected developer to which the voltage is supplied.

12. A method of supplying voltage to a developing apparatus, comprising:
selecting a developer from among a plurality of developers;
providing a first voltage to the selected developer; and
providing a second voltage to the developers other than the selected developer to which the voltage is supplied.

13. The method of supplying voltage to a developing apparatus according to claim 12, wherein the second voltage is a lower voltage than the first voltage.

14. The method of supplying voltage to a developing apparatus according to claim 12, wherein the second voltage is a variable voltage.

15. The method of supplying voltage to a developing apparatus of claim 14, wherein the second variable voltage is supplied by a contamination prevention voltage supply portion.

16. An image forming apparatus comprising:
a voltage supply portion to supply voltage to a plurality of developers;
a voltage switching portion providing a voltage supplied by the voltage supply portion to one of the developers through switching operation and grounding the developers other than the developer to which the voltage is supplied; and
a processing portion controlling the switching operation of the voltage switching portion.
